(19) United States
(12) Patent Application Publication
(10) Pub. No.: US 2003/0075124 A1
(43) Pub. Date: Apr. 24, 2003

(54) Method and apparatus for dissipating heat from a combustion chamber of an internal combustion engine

(76) Inventor: David F. Haman, Palm City, FL (US)

Correspondence Address: Cook & Franke S.C., 660 East Mason Street, Milwaukee, WI, 53202, US

(21) Appl. No.: 10/268,430

(22) Filed: Oct. 10, 2002

Related U.S. Application Data
(60) Provisional application No. 60/335,201, filed on Oct. 23, 2001.

(51) Int. Cl. F02B 33/04

(52) U.S. Cl. 123/73 PP

(57) ABSTRACT

Air-cooling of a piston in an internal combustion engine is provided. A passageway is configured to pass a portion of the combustion air as the piston reciprocates in the cylinder. The passageway includes a through hole in the wrist pin or mutually aligned openings in the skirt of the piston, preferably above the wrist pin, and a corresponding opening in the engine block to transfer air therethrough. The additional air supplied therethrough is sufficient to substantially reduce heat transferred from the piston upper surface portion to the skirt of the piston.

### CROSS-REFERENCE TO RELATED APPLICATION

The present application claims priority of U.S. provisional application No. 60/335,201 filed Oct. 23, 2001.

### BACKGROUND OF THE INVENTION

The present invention relates generally to internal combustion engines and, more particularly, to two-stroke direct fuel-injected engines having pistons including an air-cooled wrist pin boss. The invention further relates to marine propulsion devices incorporating such engines.

Management of piston/cylinder heat load has become more problematic as improvements in performance of marine internal combustion engines are achieved. High heat load during operation at high engine speeds, has been known to lead to premature engine failure due to excessive wear between the bearing surfaces of the piston and connecting rod. That is, the piston and connecting rod are connected together by means of a wrist pin which extends through the connecting rod and through aligned holes in the piston skirt. The piston may or may not have a separate insertable wrist pin bearing in the skirt. The clearance between the wrist pin and wrist pin holes, or bearings, must be maintained so that an oil film of proper thickness is maintained between the wrist pin and the bearing or piston skirt. If this thickness exceeds specifications, localized overheating can occur causing excessive wear of the wrist pin holes or bearings, and ultimately failure will ensue.

One of the factors which can lead to excessive and premature wear of the piston's wrist pin bearing surfaces is localized overheating thereof caused by the conduction of heat from the head of the piston. Particularly, in highly efficient two-stroke direct fuel injected engines the process of scavenging, that is, purging exhaust gases from the cylinder and filling it with a fresh air/fuel charge may result in scavenging paths not necessarily conducive to heat reduction. That is, the scavenging charge is absent fuel, therefore, the charge is unable to pull heat from the piston via latent heat evaporation. This heat is transmitted directly to the head of the piston, which is generally made of aluminum or other good thermal conductor, and is conducted along the piston skirt to the wrist pin bearing surfaces. The transfer of heat is enhanced because the wrist pins are normally supported in wrist pin bosses, which are substantially thicker than the remainder of the piston skirt and serve as excellent heat transfer sections.

As the engine is operated under high loads, the temperature of the wrist pin bearing surfaces rises and the viscosity of the oil decreases. At high temperatures, the lubricity of the oil can become virtually non-existent, resulting in little or no oil film to support the load between the wrist pin and the piston. As a result, metal to metal contact between the wrist pin and the wrist pin boss or bearing may occur, eventually causing the piston assembly to fail.

In view of the foregoing issues, it would be desirable to provide a low-cost and efficient means of cooling the assembly to substantially remove heat transferred from the piston upper surface portion to the vicinity of the wrist pin in order to increase the reliability and durability of internal combustion engines, particularly, marine engines that use direct fuel injected devices. It would be further desirable to provide wrist pin cooling that does not compromise high engine performance.

### BRIEF DESCRIPTION OF THE INVENTION

The present invention is directed to a system and method to cool a piston of an internal combustion engine.

Generally, the present invention fulfills the foregoing needs by providing in one exemplary embodiment a two-stroke internal combustion engine having an engine block with a cylinder having a longitudinal axis and an upper end. The engine block has a transfer port configured to allow passage of a combustion-supporting fluid from a crankshaft chamber into the cylinder. A piston is reciprocally moveable in the cylinder along the longitudinal axis. The piston has an upper surface portion and a generally cylindrical body extending from that upper surface. A cylinder head includes a lower surface portion closing the upper end of the cylinder to define a combustion chamber between the piston upper surface and the cylinder head lower surface portion. A wrist pin is configured to pass through the piston skirt between a pair of mutually facing pin-receiving holes. A passageway is configured in the engine block to pass a portion of the combustion-supporting fluid as the piston reciprocates in the cylinder. The portion being sufficient to substantially reduce heat transferred from the piston upper surface portion toward the vicinity of the pin-receiving holes.

Accordingly, in one aspect of the invention, a two-stroke internal combustion engine is provided having an engine block defining a cylinder with a longitudinal axis and an upper end. The engine block further has a transfer port configured to pass air or an air/oil mixture into the cylinder from a crankcase chamber. A piston is reciprocally movable in the cylinder along the longitudinal axis and has an upper surface portion and a generally cylindrical body extending from the upper surface. A cylinder head is provided that includes a lower surface portion closing the upper end of the cylinder to define a combustion chamber between the piston's upper surface and the cylinder head lower surface portion. A wrist pin is configured to pass through the piston body between a pair of mutually facing pin-receiving holes in the piston and a passageway is provided in the engine block and piston, configured to pass additional air into the combustion chamber when the piston is at or near bottom-dead-center to reduce heat transferred through the piston.

Various other features, objects and advantages of the present invention will be made apparent from the following detailed description and drawings.

### DESCRIPTION OF THE DRAWINGS

The drawings illustrate one preferred embodiment presently contemplated for carrying out the invention.

In the drawings:

FIG. 1 is a side elevational view of an exemplary marine propulsion device incorporating the present invention;

FIG. 2 is a partial sectional view of an exemplary engine embodying the present invention;

FIG. 3 is partial-sectional view of a portion of the cylinder and piston assembly shown in FIG. 2 illustrating one exemplary embodiment wherein a passageway extends above a wrist pin in the body of the piston;

FIG. 4 is a perspective view of the piston shown in FIG. 3; and

FIG. 5 is a view similar to that of FIG. 3 illustrating another exemplary embodiment wherein a passageway extends through the interior of the wrist pin.

Before any embodiment of the invention is explained in detail, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

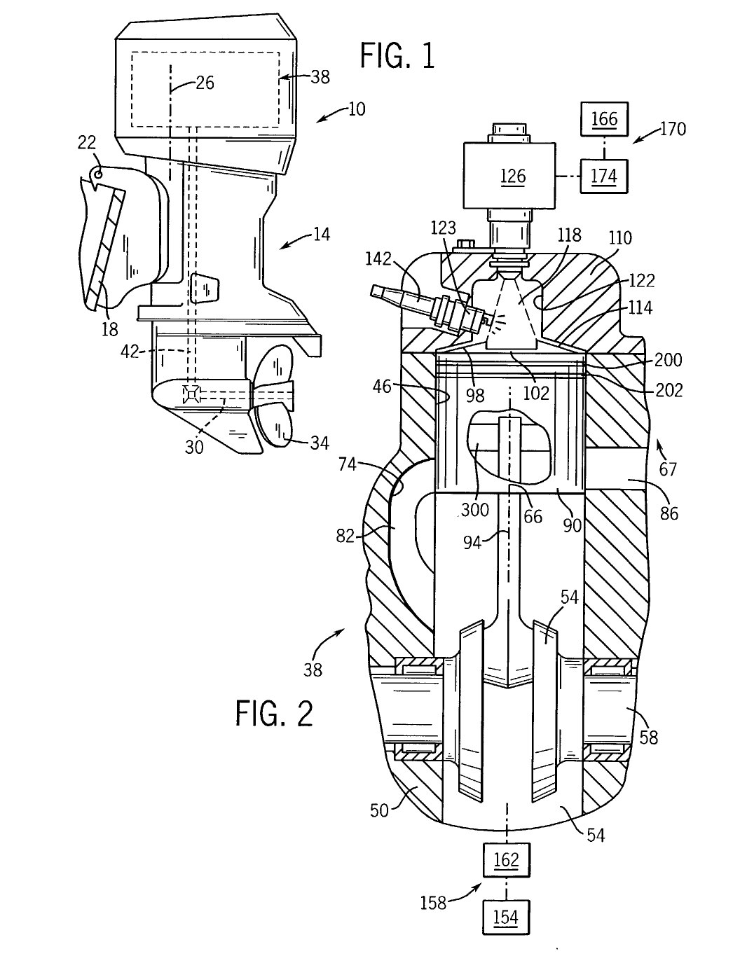

An exemplary marine propulsion device 10 embodying the invention is illustrated in FIG. 1. The marine propulsion device 10 includes an outboard drive unit 14 adapted to be mounted to the transom 18 of a boat for pivotal tilting movement relative thereto about a generally horizontal tilt axis 22 and for pivotal steering movement relative thereto about a generally vertical steering axis 26. The drive unit 14 includes a propeller shaft 30 having a propeller 34 extending therefrom and affixed thereto. The drive unit 14 also includes a direct fuel-injected, two-stroke internal combustion engine 38 drivingly connected to the propeller shaft 30 by a standard drive train 42. In one exemplary embodiment of the invention, the engine 38 may be a six-cylinder V-engine. It should be understood, however, that the invention is applicable to other types of engines with any number of cylinders. It should be further understood that the present invention need not be limited to outboard drives since other types of marine propulsion devices, such as stem drives, could also benefit from the present invention, as well as any internal combustion engine.

FIG. 2 illustrates an exemplary construction of a multi-cylinder engine embodying the present invention. For the sake of clarity and brevity only one cylinder 46 of the engine is illustrated in FIG. 2. The engine includes an engine block 50 defining a crankcase chamber 54 and having a crankshaft 58 rotatable therein. Engine block 50 also defines cylinder 46, which has a longitudinal axis 66 and an upper end 67. The engine block 50 also has respective intake ports communicating with cylinder 46. Each of the ports communicates with the crankcase chamber 54 via a respective transfer passage 82 (one shown in FIG. 2). The engine block 50 also has an exhaust port 86 which communicates with the cylinder 46 and which may be located diametrically opposite one of the intake ports.

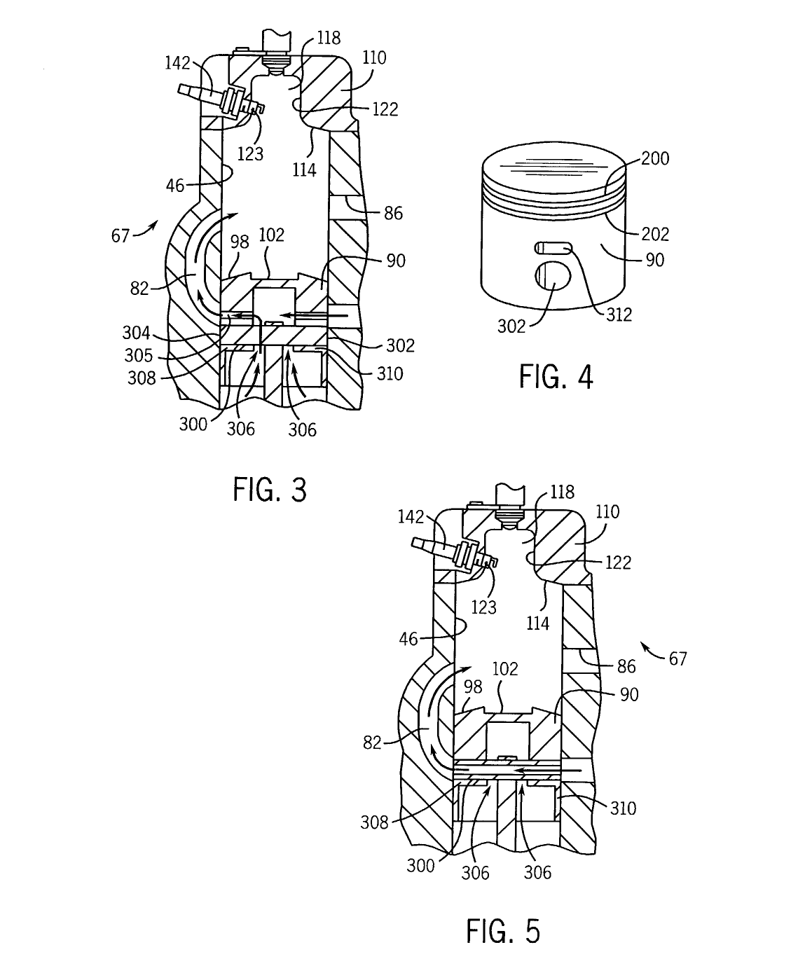

The engine also includes a piston 90 having a generally cylindrical body reciprocally moveable in the cylinder 46 along the axis 66. The piston includes grooves 200 and 202 for receiving a respective piston ring. The piston 90 is drivingly connected to the crankshaft 58 by a connecting rod 94 supported for journaling motion via a wrist pin 300. As will be readily understood by one of ordinary skill in the art and shown in FIG. 3, wrist pin 300 is configured to pass through the piston body between a pair of mutually facing pin-receiving holes 302 and 304 that extend through respective wrist pin bosses 308 and 310. A bushing or bearing may be fit in the pin-receiving holes 302 and 304 in a known manner.

The engine also includes a cylinder head 110 including a lower surface portion 114 closing the upper end 67 of the cylinder 46 so as to define a combustion chamber 118 between the piston upper surface 98 and the cylinder head lower surface portion 114. When the piston 90 is at top-dead-center, the piston upper surface 98 is spaced a predetermined distance from the cylinder head lower surface portion 114. The cylinder head lower surface portion 114 extends generally perpendicular to the cylinder axis 66 and has therein an upwardly extending recess or dome 122. The cylinder head lower surface portion 114 surrounding the recess 122 is concave and is complementary with the piston upper surface 98. In the exemplary embodiment shown, the recess 122 is located directly above a cavity 102 and is generally cylindrical and centered on the cylinder axis 66. The cylinder head 110 includes a threaded passage 123 to receive therein spark plug 142 that is used to ignite combustion in combustion chamber 118.

The engine also includes a fuel supply system 170 for supplying fuel from a fuel tank 166 to the various fuel injectors 126 of the engine 38. The fuel supply system 170 includes a fuel pump 174 communicating between the fuel tank 166 and the fuel injectors 126. The engine may include a source of lubricant which is mixed into the fuel system 170 and injected into the cylinders 46. In some cases, the purpose of this mixed oil-fuel lubricant is to reduce spark plug fouling. Although a separate lubricant source could be employed, the source of the fuel and the lubricant may be a single fuel tank 166 having therein a pre-mixture of fuel and oil. The engine further includes an oiling system 158. Oiling system 158 includes an oil pump 162 that provides oil from oil reservoir 154 to the engine.

As shown in FIG. 3, a passageway 305 is configured to pass a portion of the combustion supporting fluid, e.g., fresh charging air from crankcase chamber 54 to combustion chamber 118 through path 306. As the piston reciprocates from bottom dead-center (FIG. 3) to top-dead-center (FIG. 2), pressure differences between the crankcase chamber 54 and combustion chamber 118 causes charging air to rush through path 306 and then through passageway 305 and finally through passage 82. As shown in FIG. 4, in one exemplary embodiment, passageway 305 includes a respective opening 312 positioned above pin-receiving hole 302 so as to remove heat that otherwise could overheat the wrist pin and any corresponding surfaces in the pin-receiving holes. As shown in FIG. 3, the piston 90 of FIG. 4 has a diametrically opposed opening above pin-receiving hole 304 similarly situated to the one shown in FIG. 4. It will be appreciated that the shape of opening 312 need not be limited to a rectangular shape since other geometrical configurations could equivalently be used. Further, each of the openings 312 need not be limited to two discrete openings, as multiple openings could equivalently be used.

FIG. 5 illustrates another exemplary embodiment wherein wrist pin 300 may be constructed as a hollow wrist pin, in lieu of a solid pin, so that passageway 306 is defined through the interior of wrist pin 300. It will be appreciated that the embodiment of FIG. 5 could be optionally combined with the embodiment of FIG. 3. For example, the overall air-cooling passageway could be made up of respective separate passageways through the interior of the wrist pin and openings above the pin-receiving holes.

It will be appreciated by those skilled in the art that the present invention is applicable in any internal combustion engine, but has particular advantages in a two-stroke, direct fuel-injected engine. In particular, this invention was designed with a fuel-injection system commonly referred to as single fluid, direct fuel injection delivery system. Another type of injector system uses a high pressure pump for pressurizing a high pressure line to deliver fuel to the fuel injector through a fuel rail that delivers fuel to each injector. A pressure control valve may be coupled at one end of the fuel rail to regulate the level of pressure of the fuel supplied to the injectors to maintain a substantially constant pressure therein. The pressure may be maintained by dumping excess fuel back to the vapor separator through a suitable return line. The fuel rail may incorporate nipples that allow the fuel injectors to receive fuel from the fuel rail. Thus, in this case, it is believed that a substantially steady pressure differential, as opposed to a pressure surge, is maintained between the fuel rail and the nipples to inject fuel into the fuel chamber. Another example of direct fuel injection is a dual-fluid injection system that includes a compressor or other compressing means configured to provide a source of gas under pressure to effect injection of the fuel to the engine. That is, fuel injectors that deliver a metered individual quantity of fuel entrained in a gas. It is to be understood, however, that the present invention is not limited to any particular type of fuel injector.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

The present invention has been described in terms of the preferred embodiment, and it is recognized that equivalents, alternatives, and modifications, aside from those expressly stated, are possible and within the scope of the appending claims.,

1. A two-stroke internal combustion engine comprising:
an engine block defining a cylinder having a longitudinal axis and an upper end, the engine block further having a transfer port configured to pass air into the cylinder from a crankshaft chamber;
a piston reciprocally moveable in the cylinder along the longitudinal axis, the piston comprising an upper surface portion and a generally cylindrical body extending from the upper surface;
a cylinder head including a lower surface portion closing the upper end of the cylinder to define a combustion chamber between the piston upper surface and the cylinder head lower surface portion;
a wrist pin configured to pass through the piston body between a pair of mutually facing pin-receiving holes in the piston; and
a passageway in the engine block and piston configured to pass additional air into the combustion chamber when the piston is at or near bottom dead-center to reduce heat transferred through the piston.

2. The internal combustion engine of claim 1 wherein the passageway in the piston is through one of a wrist pin of the piston and a skirt of the piston.

3. The internal combustion engine of claim 1 wherein the passageway comprises a respective opening above each pin-receiving hole in the piston.

4. The internal combustion engine of claim 3 wherein the wrist pin is a solid wrist pin.

5. The internal combustion engine of claim 1 wherein the wrist pin has the passageway therethrough.

6. The internal combustion engine of claim 1 wherein the piston cylindrical body includes a pair of mutually opposite relatively thick wrist pin bosses, and further wherein the pair of pin-receiving holes and the respective openings extend through the bosses.

7. The internal combustion engine of claim 1 wherein a portion of combustion-supporting fluid passes through the passageway in response to a pressure differential as the piston moves from top dead-center to bottom-dead-center in the cylinder.

8. The internal combustion engine of claim 1 wherein the engine further comprises a fuel injector for directly injecting fuel into the combustion chamber.

9. The internal combustion engine of claim 8 wherein the fuel injector is configured to deliver fuel to the combustion chamber not entrained in a gas.

10. The internal combustion engine of claim 9 wherein the fuel injector delivers fluid due to a pressure surge.

11. The internal combustion engine of claim 9 wherein the fuel injector delivers fluid due to a pressure differential.

12. The internal combustion engine of claim 8 wherein the fuel injector is configured to deliver fuel that is entrained in a predetermined gas to the chamber.

13. The internal combustion engine of claim 12 wherein the predetermined gas is air.

14. The internal combustion engine of claim 12 further comprising a compressor and wherein the fuel is compressed to be entrained within the predetermined gas by the compressor.

15. A direct fuel injection internal combustion engine comprising:
engine block defining a cylinder having a longitudinal axis and an upper end;
a piston reciprocally moveable in the cylinder along the longitudinal axis, the piston comprising an upper surface portion and a generally cylindrical body extending from the upper surface;
a cylinder head including a lower surface portion closing the upper end of the cylinder to define a combustion chamber between the piston upper surface and the cylinder head lower surface portion;
a fuel injector for directly injecting fuel into the combustion chamber;
a wrist pin configured to pass through the piston between a pair of mutually facing pin-receiving holes; and
a passageway configured to pass additional combustion air through to the cylinder as the piston reciprocates in the cylinder to substantially reduce heat transferred from the piston upper surface portion toward the vicinity of the pin-receiving holes, the passageway at least partially located in one of the cylindrical body of the piston and the wrist pin.

16. The internal combustion engine of claim 15 wherein the passageway includes a respective opening above each pin-receiving hole and the wrist pin is a solid wrist pin.

17. The internal combustion engine of claim 15 wherein the wrist pin comprises a hollow wrist pin and the passageway is defined through the wrist pin.

18. The internal combustion engine of claim 15 wherein the piston cylindrical body includes a pair of mutually opposing relatively thick wrist pin bosses, and wherein the pair of pin-receiving holes and the respective openings extend through the wrist pin bosses.

19. The internal combustion engine of claim 15 wherein the additional combustion air passes through the passageway in response to a pressure differential as the piston moves from top-dead-center to bottom-dead-center in the cylinder.

20. The internal combustion engine of claim 15 wherein the engine is a two-stroke engine and wherein the fuel injector is configured to deliver to the combustion chamber fuel comprising a single fluid.

21. The internal combustion engine of 20 wherein the fuel injector delivers fluid due to a pressure surge.

22. The internal combustion engine of claim 20 wherein the fuel injector delivers fluid due to a pressure differential.

23. The internal combustion engine of claim 15 wherein the fuel injector is configured to deliver to the chamber fuel that is entrained in a gas.

24. An internal combustion engine having a cylinder and comprising:
a piston having a generally cylindrical body including a pair of holes mutually aligned relative to one another to receive a wrist pin therethrough; a passageway comprising respective openings above each pin receiving hole, each opening configured to pass a portion of a combustion air as the piston reciprocates in the cylinder, the portion being sufficient to substantially reduce heat transferred from an upper surface of the piston toward the vicinity of the pin-receiving holes; and
a marine propulsion unit being coupled to receive driving power from the engine.

25. The internal combustion engine of claim 24 wherein the engine further comprises a fuel injection system to directly inject fuel into the combustion chamber.

26. An outboard motor comprising:
a two-stoke internal combustion engine, the engine including:
an engine block defining a cylinder having a longitudinal axis and an upper end, the engine block further defining a transfer port for passing into the cylinder a combustion-supporting fluid from a crankshaft chamber;
a piston reciprocally moveable in the cylinder along the axis, the piston comprising an upper surface portion and a generally cylindrical body extending from the upper surface;
a cylinder head including a lower surface portion closing the upper end of the cylinder to define a combustion chamber between the piston upper surface and the cylinder head lower surface portion;
a wrist pin configured to pass through the piston body into a pair of mutually facing pin-receiving holes;
a passageway comprising one of a respective opening above each pin-receiving hole and an opening therethrough the wrist pin to pass a portion of the combustion-supporting fluid as the piston reciprocates in the cylinder, the portion being sufficient to substantially reduce heat transferred from the piston upper surface portion toward the vicinity of the pin-receiving holes; and
a marine propulsion unit coupled to the engine to drive the outboard motor.

27. The outboard motor of claim 26 wherein the two-stroke internal combustion engine includes a two-stroke direct fuel injected engine.

28. A boat comprising:
a transom having an outboard motor mounted thereto;
an internal combustion engine configured to provide driving power to a marine propulsion unit, the internal combustion engine including:
a cylinder configured to receive a combustion-supporting fluid from a crankshaft chamber;
a piston reciprocally moveable in the cylinder;
a wrist pin configured to pass through the piston into a pair of mutually facing pin-receiving holes; and
a passageway configured to transport an additional portion of the combustion-supporting fluid during reciprocation of the piston.

29. The boat of claim 28 wherein the engine further includes a fuel injector for directly injecting fuel into the combustion chamber and wherein the passageway is one of:
a respective opening above each pin-receiving hole; and
an opening in the wrist pin such that the passageway is defined through the wrist pin.

30. The boat of claim 28 wherein the portion of combustion-supporting fluid is sufficient to reduce heat transferred from the piston toward the vicinity of the pin-receiving holes.

31 A method for dissipating heat in an internal combustion engine, the method comprising the steps of:
providing a combustion chamber;
providing a reciprocally moveable piston within the combustion chamber, the piston has an upper portion and a cylindrical body extending therefrom;
positioning a wrist pin through the piston cylindrical body;
defining a heat transfer passageway through one of the wrist pin and a skirt of the wrist pin; and
directing a portion of combustible fluid through the heat transfer passageway during activation of the piston.

32. The method of claim 31 further comprising the step of removing heat being transferred from the piston upper surface toward the piston skirt.

33. The method of claim 31 wherein the step of directing further comprises the step of applying a pressure surge to the combustion chamber.
